(19) United States
(12) Patent Application Publication
(10) Pub. No.: US 2025/0319729 A1
(43) Pub. Date: Oct. 16, 2025

(54) COUPLING DEVICE FOR A VEHICLE TRAILER

(71) Applicant: Christine SCHARMÜLLER, Fornach (AT)

(72) Inventor: Christine SCHARMÜLLER, Fornach (AT)

(21) Appl. No.: 19/172,047

(22) Filed: Apr. 7, 2025

(30) Foreign Application Priority Data
Apr. 10, 2024 (AT) A 50305/2024

(51) Int. Cl. B60D 1/36; B60D 1/02

(52) U.S. Cl. CPC B60D 1/36; B60D 1/02

(57) ABSTRACT

Coupling device for a vehicle trailer including a coupling housing with a receiver and a coupling ring with a coupling element. End region of the coupling ring is arranged in the receiver. The coupling ring is transferable between a fixed state and a mobile state by a locking device of the coupling device. Coupling ring is connected in a substantially rigid manner to the coupling housing in the fixed state and is movable in the mobile state at least within a limited movement range. Substantially rod-shaped movement-limiting part is formed on end region of the coupling ring and at least one end region of the movement-limiting part is arranged in a recess of the receiver. As measured in the fixed state, length of the recess along longitudinal axis of coupling ring is at least 1.5 times the thickness of the movement-limiting part along the longitudinal axis of the coupling ring.

### CROSS-REFERENCE TO RELATED APPLICATIONS

The present application claims the benefit of Austrian Patent Application No. A 50305/202, filed Apr. 10, 2024, entitled “COUPLING DEVICE FOR A VEHICLE TRAILER”, which is incorporated by reference in its entirety.

### BACKGROUND OF THE INVENTION

### 1. Field of the Invention

The invention relates to a coupling device for a vehicle trailer.

### 2. Description of the Related Art

It is known that trailers or work equipment for agricultural and forestry vehicles are attached to a trailer hitch of a towing vehicle such as a tractor by means of a coupling ring and are towed by the towing vehicle. Such trailer hitches are designed to pull several tons of trailing load with the towing vehicle, but coupling the trailer or work equipment to the towing vehicle is often a complex task due to the weight of the trailer or the work equipment. It is therefore not uncommon for the trailer or work equipment to remain attached to the tractor for some time if the tractor is not needed for other purposes in the meantime.

As a rule, the vehicle trailer has a coupling ring which is coupled to the trailer hitch of the towing vehicle. Even though coupling a standard trailer to a towing vehicle is a very simple matter in theory, coupling heavy agricultural and forestry vehicles to heavy trailers, each of which can weigh more than 16 tons depending on the category, is a difficult and strenuous affair. This situation is further complicated by the fact that, in many countries, the diameter of the coupling ring opening and the diameter of the coupling pin of the trailer hitch are standardized.

For this reason, for example, a clearance between the coupling pin and an inner wall of the coupling ring opening can only be between 1 and 4 mm if the coupling pin is arranged in the coupling ring opening. In practice, it is hardly possible to position a tractor weighing several tons so precisely that the opening of the coupling element of the coupling ring is aligned with the connecting link of the trailer hitch, in particular the coupling pin.

Furthermore, positioning the tractor and the trailer in relation to one another always involves dangerous handling in a confined space at a coupling point between the trailer hitch and the coupling ring, which exposes the person handling the coupling point to a high risk of injury, particularly hand injuries.

It is therefore the object of the invention to provide a coupling device for vehicle trailers of the type mentioned at the outset with which the abovementioned drawbacks can be avoided and with which the coupling of a heavy vehicle trailer to a tractor can be facilitated.

This provides the advantage that, in the mobile state, the coupling ring can be extended at least partially out of the coupling housing of the coupling device. By limiting the range of motion in which the coupling ring can be moved, the alignment of the coupling ring in a trailer hitch, for example within a receiving space of a trailer hitch, and the coupling with the trailer hitch, in particular with a coupling pin, can be facilitated substantially. By virtue of the range of motion that the motion limiting part has in the recess, the range of motion can also be projected onto the coupling element, thus enabling the coupling element to also perform a movement within a limited range of motion. This allows the coupling element to be easily coupled to the connecting link of the trailer hitch; after coupling, the coupled tractor or the coupled vehicle trailer need only be moved in the direction of the receiver in order to transfer the coupling device into a locking position, with the subsequent result that only the coupling device has to be fixed in the locking position. This can also enhance safety when coupling the vehicle trailer to the trailer hitch, particularly in terms of hand injuries, since the limited range of movement during the coupling process can reduce stresses between the vehicle trailer and the towing vehicle. This can reduce the risk of injury during handling at a coupling point between the trailer hitch and the coupling ring, which usually has to be carried out when bringing the vehicle trailer and the towing vehicle together and takes place in a very confined space at the coupling point, since on the one hand there are lower stresses between the vehicle trailer and the trailer hitch and, on the other hand, the time required for handling can be reduced. The value for the length of the recess, i.e., 1.5 times the thickness of the movement-limiting part along the longitudinal axis of the coupling ring, is selected in such a way that it significantly exceeds any manufacturing-related play.

The invention further relates to a method for coupling a trailer hitch to the inventive coupling device.

### SUMMARY OF THE INVENTION

It is therefore the object of the invention to provide a coupling device for vehicle trailers of the type mentioned at the outset with which the abovementioned drawbacks can be avoided and with which the coupling of a heavy vehicle trailer to a tractor can be facilitated.

This provides the advantage that, in the mobile state, the coupling ring can be extended at least partially out of the coupling housing of the coupling device. By limiting the range of motion in which the coupling ring can be moved, the alignment of the coupling ring in a trailer hitch, for example within a receiving space of a trailer hitch, and the coupling with the trailer hitch, in particular with a coupling pin, can be facilitated substantially. By virtue of the range of motion that the motion limiting part has in the recess, the range of motion can also be projected onto the coupling element, thus enabling the coupling element to also perform a movement within a limited range of motion. This allows the coupling element to be easily coupled to the connecting link of the trailer hitch: after coupling, the coupled tractor or the coupled vehicle trailer need only be moved in the direction of the receiver in order to transfer the coupling device into a locking position, with the subsequent result that only the coupling device has to be fixed in the locking position. This can also enhance safety when coupling the vehicle trailer to the trailer hitch, particularly in terms of hand injuries, since the limited range of movement during the coupling process can reduce stresses between the vehicle trailer and the towing vehicle. This can reduce the risk of injury during handling at a coupling point between the trailer hitch and the coupling ring, which usually has to be carried out when bringing the vehicle trailer and the towing vehicle together and takes place in a very confined space at the coupling point, since on the one hand there are lower stresses between the vehicle trailer and the trailer hitch and, on the other hand, the time required for handling can be reduced. The value for the length of the recess, i.e., 1.5 times the thickness of the movement-limiting part along the longitudinal axis of the coupling ring, is selected in such a way that it significantly exceeds any manufacturing-related play.

The invention further relates to a method for coupling a trailer hitch to the inventive coupling device.

It is therefore also an object of the invention to specify a generic concept of the type mentioned at the outset with which the coupling of a heavy vehicle trailer to a tractor can be facilitated.

The advantages of the method correspond to the advantages of the abovementioned generic concept.

### BRIEF DESCRIPTION OF THE DRAWINGS

The subclaims relate to additional advantageous embodiments of the invention. The invention will be described in greater detail with reference to the accompanying drawings, in which only preferred embodiments are shown by way of example. In the drawings:

FIG. 1 shows a preferred embodiment of the coupling device in an axonometric representation,

FIG. 2 shows the preferred embodiment of the coupling device shown in FIG. 1 in a front view,

FIG. 3 shows the preferred embodiment of the coupling device shown in FIG. 1 in a side view from the left,

FIG. 4 shows the preferred embodiment of the coupling device shown in FIG. 1 in a plan view,

FIG. 5 is a longitudinal section through the preferred embodiment of the coupling device in the fixed state,

FIG. 6 shows a section parallel to the horizontal pivot plane of the preferred embodiment of the coupling device in the fixed state,

FIG. 7 shows another section parallel to the horizontal pivot plane of another preferred embodiment of the coupling device in the mobile state,

FIG. 8 shows the section of the coupling device shown in FIG. 6 in the mobile state in a first horizontally pivoted position of the coupling ring,

FIG. 9 shows the section of the coupling device shown in FIG. 6 in the mobile state in a second horizontally pivoted position of the coupling ring,

FIG. 10 shows a preferred embodiment of a coupling system comprising the preferred embodiment of the coupling device and a trailer hitch,

FIG. 11 shows another longitudinal section through the preferred embodiment of the coupling device in the mobile state in a vertically pivoted position, and

FIG. 12 shows another longitudinal section through the preferred embodiment of the coupling device in the mobile state in a horizontal end position.

### DETAILED DESCRIPTION

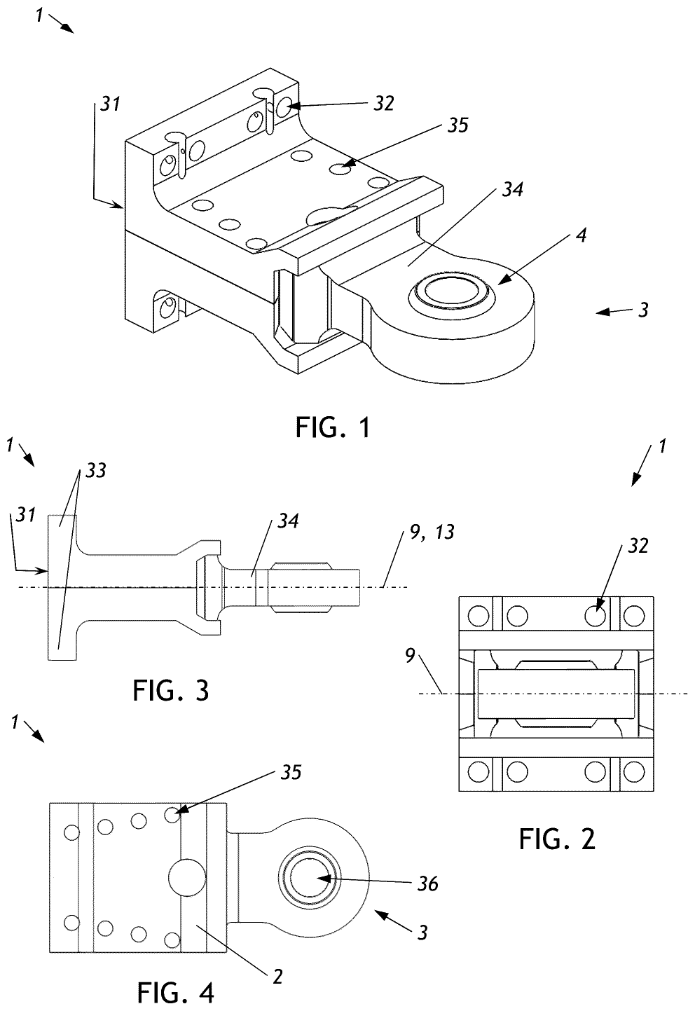

FIGS. 1 to 12 show at least parts of a coupling device 1 for a vehicle trailer comprising a coupling housing 2 and a coupling ring 3 with a coupling element 4, wherein an end region of the coupling ring 3 opposite the coupling element 4 is arranged in a receiver 5 of the coupling housing 2, wherein the coupling ring 3 can be transferred between a fixed state 7 and a mobile state 8 by means of a locking device 6 of the coupling device 1, wherein the coupling ring 3 is connected in a substantially rigid manner to the coupling housing 2 in the fixed state 7 and is movable in the mobile state 8 at least within a limited range of movement relative to the coupling housing 2 on a horizontal pivot plane 9, wherein a substantially rod-shaped movement-limiting part 10 is formed on the end region of the coupling ring 3 arranged in the receiver 5, wherein at least one end region of the rod-shaped movement-limiting part 10 is in a recess 11 arranged in the receiver 5 of the coupling housing 2 and, in the mobile state 8, limits the movement of the coupling ring 3 relative to the coupling housing 2, wherein—as measured in the fixed state 7—the length of the recess 12 along the longitudinal axis of the coupling ring 13 is at least 1.5 times the thickness of the movement-limiting part 14 along the longitudinal axis of the coupling ring 13.

Furthermore, a method for coupling a trailer hitch 28 with the coupling device 1 according to the invention is provided, wherein the coupling device 1 is transferred from the fixed state 7 into the mobile state 8 by means of the locking device 6, wherein, in the mobile state 8, the coupling ring 3 is coupled to the trailer hitch 28 by means of the coupling element 4, and wherein, after the coupling of the coupling ring 3 with the trailer hitch 28, the coupling ring 3 is brought into a locking position and the coupling device 1 is fixed in the fixed state 7 by means of the locking device 6.

This provides the advantage that, in the mobile state 8, the coupling ring 3 can be extended at least partially out of the coupling housing 2 of the coupling device 1. By limiting the range of motion in which the coupling ring 3 can be moved, the alignment of the coupling ring 3 in a trailer hitch 28, for example within a receiving space of a trailer hitch 28, and the coupling with the trailer hitch 28, in particular with a coupling pin 29, can be facilitated substantially. By virtue of the range of motion that the movement-limiting part 10 has in the recess 11, the range of motion can also be projected onto the coupling element 4, so that the coupling element 4 can also perform a movement in a limited range of motion. As a result, the coupling element 4 can be easily coupled to the connecting link of the trailer hitch 28; after coupling, only the coupled tractor or the coupled vehicle trailer need be moved in the direction of the receiver 5 in order to transfer the coupling device 1 into a locking position, with the subsequent result that only the coupling device 1 has to be fixed in the locking position. This can also enhance safety during coupling of the vehicle trailer to the trailer hitch 28, particularly with regard to hand injuries, since the limited range of movement during the coupling process can reduce stresses between the vehicle trailer and the towing vehicle. This can reduce the risk of injury during handling at a coupling point between the trailer hitch 28 and the coupling ring 3, which usually has to be carried out when bringing the vehicle trailer and the towing vehicle together and takes place in a very confined space at the coupling point, since on the one hand there are lower stresses between the vehicle trailer and the trailer hitch 28 and, on the other hand, the time required for handling can be reduced. The value for the length of the recess 12—i.e., 1.5 times the thickness of the movement-limiting part 14 along the longitudinal axis of the coupling ring 13—is selected such that it significantly exceeds any manufacturing-related play.

The coupling device 1 and/or the trailer hitch 28 are preferably a device for agricultural and forestry vehicles. The coupling device 1 and/or the trailer hitch 28 are designed to be able to pull several tons of trailing load, in particular at least two tons of trailing load, preferably at least four tons of trailing load.

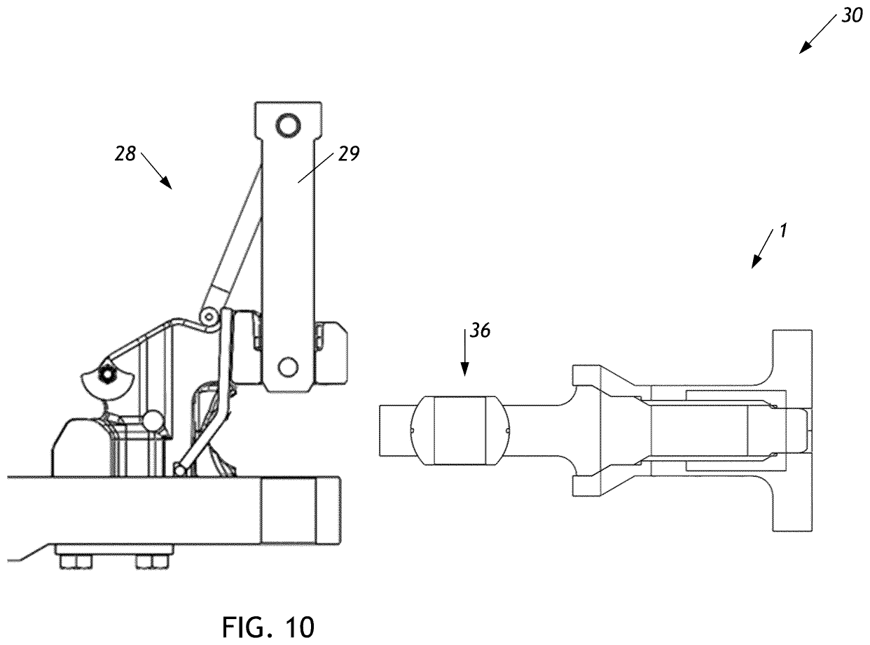

The trailer hitch 28 is a device for coupling to a vehicle trailer and/or work equipment. Work equipment can be understood, for example, to be a baler, a slurry tank trailer, a soil tillage device, or the like. For the coupling of the vehicle trailer or the working device to the trailer hitch 28, the vehicle trailer or the working device has the coupling device 1 with the coupling ring 3. The vehicle trailer or work equipment is preferably a trailer or work equipment from the agricultural and forestry sector and therefore has a different size and mass than a normal vehicle trailer for passenger cars. The coupling device I can be connected to a coupling pin 29 of the trailer hitch 28. When the trailer hitch 28 is in a coupled state with the coupling ring 3 of the coupling device 1, the coupling pin 29 is arranged within a coupling hole of the coupling ring 3. In FIG. 10, a preferred embodiment of a coupling system 30 comprising the coupling device 1 according to the invention and the trailer hitch 28 is shown by way of example, the coupling device 1 not being coupled to the trailer hitch 28.

The coupling device 1 comprises a coupling housing 2. Preferably, the coupling housing 2 comprises, in particular is made of, metal.

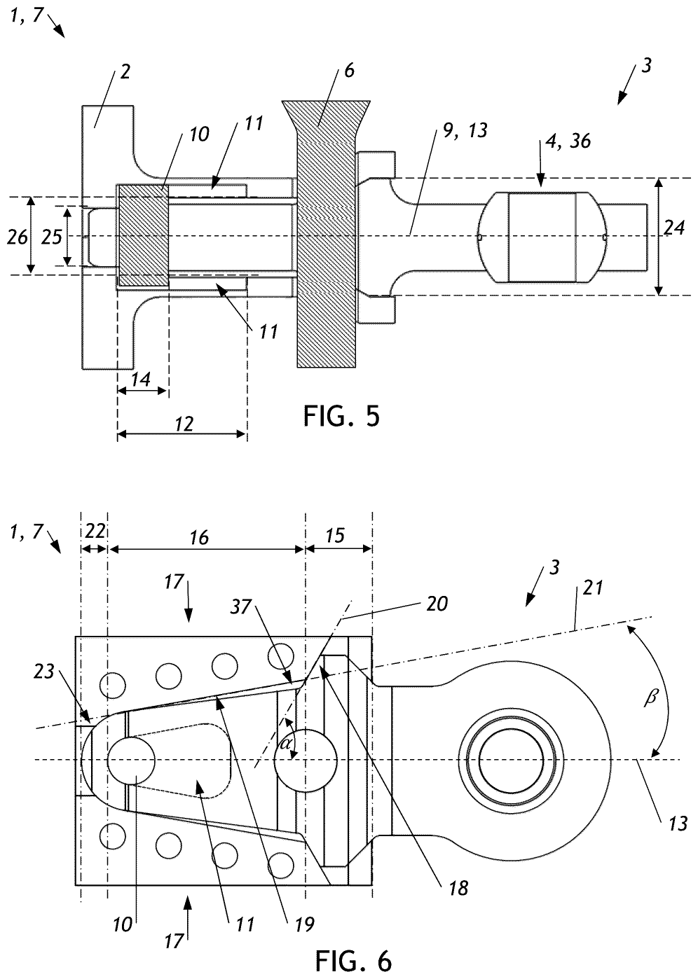

The coupling device 1 is designed such that the coupling device 1 can be attached to a vehicle trailer. Preferably, this fastening can be carried out by means of a fastening surface 31. Preferably, the coupling device 1 is attached to the vehicle trailer by means of the fastening surface 31 and fastening means. For this purpose, the fastening surface 31 can preferably have fastening holes 32 for receiving the fastening means, such as screws or bolts. The mounting surface 31 and the mounting holes 32 are shown by way of example in FIGS. 1 and 2. Preferably, the fastening surface 31 is part of the coupling housing 2. This is illustrated by way of example in FIGS. 1 and 5.

Alternatively, in order to fasten the coupling device 1 to the vehicle trailer or the like, a fastening plate can also be fastened, in particular screwed or welded, to the coupling device 1, in particular to the coupling housing 2.

Preferably, the coupling housing 2 can be a plate with brackets, in which case the receiver 5 is formed in the region between the plate and the brackets.

Preferably, the receiver 5 of the coupling housing 2 can be a cavity in the coupling housing 2, the end region of the coupling ring 3 opposite the coupling element 4 being arranged in the cavity of the coupling housing 2. This can be seen in FIGS. 5 to 10.

Preferably, the coupling housing 2 can be composed of at least two parts, in particular two parts.

Preferably, the at least two parts of the coupling housing 2 can be releasably connected to one another by fastening means. For this purpose, the coupling housing 2 can preferably have housing holes 35 for receiving the fastening means, such as screws or bolts. The housing holes 35 are shown by way of example in FIGS. 1, 4, and 6 to 9.

Especially preferably, a provision can be made that the coupling housing 2 is composed of at least two plates and that the receiver 5 of the coupling housing 2 is formed in at least one of the at least two plates. FIGS. 1 to 5 show a preferred embodiment of the coupling device 1 that is composed of two plates. As a result, the coupling device 1 can have an especially simple design which, in particular, facilitates maintenance or the replacement of damaged components.

Preferably, the two plates can be identical, in which case the two plates are arranged in mirror symmetry to one another to form the receiver 5 of the coupling housing 2. In this case, each plate thus has a part of the receiver 5, the parts being arranged opposite one another to form the cavity.

As can also be seen in the especially preferred embodiment shown in FIGS. 1 to 3, a fastening extension 33 is formed on each plate which respectively extends away from the horizontal pivot plane 9, in particular normal to the horizontal pivot plane 9. The horizontal pivot plane 9 with the fastening extensions 33 extending horizontally away therefrom is clearly visible in FIG. 3. By means of these two fastening extensions 33, the fastening surface 31 can be formed at the end of the coupling device 1 facing away from the coupling element 4. The two surfaces of the two fastening extensions 33 preferably together form the fastening surface 31.

Preferably, the coupling housing 2 can be embodied as a single piece. In that case, like in the embodiment of the coupling housing 2 consisting of at least two parts, the fastening surface 31 can be formed on the coupling housing 2 at the end of the coupling housing 2 facing away from the coupling element 4. Preferably, the fastening surface 31 can be formed by the coupling housing 2.

Preferably, the coupling housing 2 can be a cast part.

The coupling ring 3 is a component with a coupling element 4. The coupling ring 3 is part of the coupling device 1. The coupling element 4 is arranged at a first end region of the coupling ring 3, a second end region extending into the receiver 5 of the coupling housing 2. Preferably, a tow bar 34 extends away from the coupling element 4. The second end region of the coupling ring 3 arranged in the receiver 5 is part of the tow bar 34.

Preferably, the coupling ring 3 comprises, in particular is made of, metal.

Preferably, the coupling ring 3, in particular the tow bar 34, can be substantially plate-shaped.

Preferably, a guide rod can be arranged on the tow bar 34. The guide rod is arranged on the tow bar 34 outside the receiver 5. This can facilitate the guidance of the coupling ring 3 in the mobile state 8, in particular during coupling and uncoupling.

Preferably, the coupling element 4 can be a ball socket or a coupling ring hole 36. In FIGS. 1 to 10, the coupling element 4 is shown in the form of a coupling ring hole 36. The coupling ring hole 36 is an opening in the coupling ring which is able to accommodate the coupling pin 29 of the trailer hitch 28. In contrast, in the case of a coupling element 4 embodied as a ball socket, the ball socket is placed on a ball hitch of the trailer hitch 28. These two types of coupling are known coupling types from the prior art, for which reason a more detailed description of the respective coupling type has been omitted, with reference being made to the relevant specialist literature.

Preferably, the coupling ring 3 can be a ball joint coupling ring. The ball joint coupling ring is a coupling ring with a ball joint that enables positive and negative vertical pivoting of a trailer coupled to a tractor to be achieved, for example when driving through ditches. The ball joint coupling ring is a well-known component from the prior art, for which reason a more detailed description of the ball joint coupling ring has been omitted, with reference being made to the relevant specialist literature. If the coupling ring 3 is embodied as a ball joint coupling ring, the use of the coupling device 1 according to the invention also provides the advantage that twisting of the ball can be reduced during coupling. Twisting of the ball can occur very quickly during coupling using the coupling pin 29, particularly when the ball joint coupling ring is already in use. The coupling device I can reduce this through the limited range of movement, since the positioning of the coupling ring 3 can be facilitated. This also eliminates the need to reach into the vicinity of the hitch with one's hands in order to align the ball opening for the coupling pin 29, which reduces the risk of injury, particularly hand injuries.

The coupling ring 3 can be transferred between the fixed state 7 and the mobile state 8 by means of the locking device 6. The locking device 6 is part of the coupling device 1.

Especially preferably, a provision can be made that the locking device 6 is a locking pin, which locking pin can be inserted through a common through hole of the coupling ring 3 and the coupling housing 2. In FIG. 5, a locking device 6 is shown in the form of a locking pin as an example. By using a locking pin, the coupling device 1 can be transferred with particular ease between the fixed state 7 and the mobile state 8 by merely removing the locking pin. As a result, the locking device 6 can be given an especially simple design to fulfill its function.

The coupling ring 3 and the coupling housing 2 each have a hole, the two holes forming a common through hole for the locking pin. In the fixed state 7, the locking pin is arranged in this common through hole and thus prevents movement of the coupling ring 3 relative to the coupling housing 2.

Preferably, the coupling ring 3 is arranged in a locking position in the fixed state 7. The fixed state 7 is illustrated in FIG. 6 by way of example. In FIG. 6, the locking pin is omitted in order to make the common through hole visible into which the locking pin can be inserted to lock the coupling ring 3 relative to the coupling housing 2.

According to the invention, a substantially rod-shaped movement-limiting part 10 is formed on the end region of the coupling ring 3 arranged in the receiver 5. According to the invention, at least one end region of the rod-shaped movement-limiting part 10 is always arranged in the recess 11 of the coupling housing 2. This is shown by way of example in FIG. 5, where a longitudinal section through a preferred embodiment of the coupling device 1 can be seen. As can be seen in FIG. 5, both end regions of the rod-shaped movement-limiting part 10 are arranged in recesses 11 of the coupling housing 2.

Preferably, the coupling housing 2 can have two recesses 11 arranged opposite one another in the receiver 5, with a respective end region of a rod-shaped movement-limiting part 10 being arranged in a recess 11 of the two oppositely situated recesses 11.

Preferably, only one rod-shaped movement-limiting part 10 can be formed on the end region of the coupling ring 3 opposite the coupling element 4. In this case, one end region of the movement-limiting part 10 can be preferably arranged in a recess 11 of the coupling housing 2.

A movement-limiting part 10 is to be understood as being molded on, which can be formed on the one hand during the formation of the coupling ring 3, such as in the case of an injection-molded part, and on the other hand also by fastening the movement-limiting part 10 to the end region of the coupling ring 3 opposite the coupling element 4, for example by driving a pin into a drilled hole or by welding the pin to the coupling ring 3.

Preferably, the movement-limiting part 10 is a pin attached to the coupling ring 3. For this purpose, the pin is preferably arranged in a form-fitting manner in a through hole or a blind hole of the coupling ring 3.

Preferably, the movement-limiting part 10 extends normal to the longitudinal axis of the coupling ring 13 and/or extends normal to the horizontal pivot plane 9 away from the coupling ring 3.

The rod-shaped movement-limiting part 10 is intended to limit the movement of the coupling ring 3 relative to the coupling housing 2 in the mobile state 8.

In the fixed state 7, the coupling ring 3 is connected in a substantially rigid manner to the coupling housing 2. In that case, no substantially lateral or sideways movement and no vertical movement of the coupling ring 3 relative to the coupling housing 2 is possible. The fixed state 7 of the coupling device 1 is shown for the sake of example in FIGS. 5 and 6.

By releasing the locking device 6, the coupling device 1 is transferred from the fixed state 7 to the mobile state 8. In the mobile state 8, the coupling ring 3 is able to be moved out of the receiver 5 at least in the direction of the longitudinal axis of the coupling ring 13, and in particular in the sideways or lateral direction to the longitudinal axis of the coupling ring 13. This movement takes place substantially on the horizontal pivot plane 9. The horizontal pivot plane 9 is shown by way of example in FIGS. 2, 3, and 5. In the side view from the left shown in FIG. 3, and in the sectional view of the preferred embodiment of the coupling device 1 shown in FIG. 5, the longitudinal axis of the coupling ring 13 is also shown for the sake of example, which in this preferred embodiment is located on the horizontal pivot plane 9.

Preferably, the coupling ring 3 can be pulled out of the receiver 5 in a main towing direction, with the main towing direction running in the direction of the longitudinal axis of the coupling ring 13.

According to the invention, the length of the recess 12 along the longitudinal axis of the coupling ring 13 is at least 1.5 times, preferably at least 2 times, preferably at least 3 times, the thickness of the movement-limiting part 14 along the longitudinal axis of the coupling ring 13. The length of the recess 12 along the longitudinal axis of the coupling ring 13 and the thickness of the movement-limiting part 14 along the longitudinal axis of the coupling ring 13 are shown in FIG. 5. This makes it possible for the coupling ring 3 to be pulled out of the receiver 5 in the mobile state 8 for coupling with the trailer hitch 28, in particular pulled out in the main towing direction.

Preferably, the length of the recess 12 and, in particular—as measured in the fixed state 7—the thickness of the movement-limiting part 14 along the longitudinal axis of the coupling ring 13, is such that the coupling ring 3 can be pulled out in the mobile state 8 by at least 2 cm, especially preferably at least 4 cm, preferably at least 6 cm. “Being able to be pulled out” means along the direction of the longitudinal axis of the coupling ring 13, i.e., in the main towing direction.

Especially preferably, a provision can be made that—in a section parallel to the horizontal pivot plane 9—the end region of the coupling ring 3 arranged in the receiver 5 of the coupling housing 2 tapers into the receiver 5. This is shown by way of example in FIGS. 6 to 9, each of which shows a section parallel to the horizontal pivot plane 9. This ensures an especially effective hold of the coupling ring 3 in the receiver 5.

Preferably, the receiver 5 of the coupling housing 2 can taper into the receiver 5.

By tapering the receiver 5 and the end region of the coupling ring 3 into the receiver 5, an especially effective hold of the coupling ring 3 in the receiver 5 can be achieved. Furthermore, by forming the taper of the receiver 5 and the taper of the end region of the coupling ring 3, it is especially simple to increase the lateral range of movement of the coupling ring 3 relative to the width of the recess 11 by selecting a different shape for the two tapers.

Especially preferably, a provision can be made that—in a section parallel to the horizontal pivot plane 9—the recess 11 of the coupling housing 2 tapers into the receiver 5. This makes it particularly easy to achieve a sideways or lateral movement of the coupling ring 3 in the mobile state 8. The sideways or lateral movement of the coupling ring 3 takes place on the horizontal pivot plane 9.

Preferably, a provision can be made that a maximum width of the recess 11 is at least 1.5 times, preferably at least 2 times, preferably at least 3 times a second thickness of the movement-limiting part, the second thickness of the movement-limiting part being measured normal to the longitudinal axis of the coupling ring 13 and in the fixed state 7.

Preferably, the maximum width of the recess 11 and, in particular—as measured in the fixed state 7—the second thickness of the movement-limiting part, is such that the coupling ring 3 can be pivoted in the mobile state 8 by at least 3 cm, especially preferably at least 5 cm, preferably at least 7 cm, in the side or lateral direction. In the sideways or lateral direction means in the direction normal to the longitudinal axis of the coupling ring 13, i.e., normal to the main towing direction, and on the horizontal pivot plane 9.

Preferably, the end region of the movement-limiting part 10 arranged in the recess 11 has a circular cross section. In that case, the thickness of the movement-limiting part 14 corresponds to the second thickness of the movement-limiting part.

Especially preferably, a provision can be made that the coupling housing 2 comprises a first receiving section 15 in the direction of the receiver 5 and a second receiving section 16 following the first receiving section 15 along the longitudinal axis of the coupling ring 13, and that the recess 11 of the coupling housing 2 is arranged in the second receiving section 16. The first and second receiving sections 15, 16 are shown as examples in FIG. 6. As a result, the movement of the coupling ring 3 in the mobile state 8 in the lateral direction can be improved, since the recess 11 is arranged further in the receiver 5. Furthermore, this enables the shape of the receiver 5 in the receiver sections 15, 16 to be configured differently with particular ease, whereby, on the one hand, the hold of the coupling ring 3 in the receiver 5 and, on the other hand, the pivoting behavior of the coupling ring 3 can be easily adapted during the manufacture of the coupling device 1.

A provision can be especially preferably made that—in a section parallel to the horizontal pivot plane 9—the coupling housing 2 has, on at least one side of the receiver 5 facing a longitudinal side of the coupling housing 17, a substantially straight first coupling housing section 18 in the first receiver section 15 and a substantially straight second coupling housing section 19 in the second receiver section 16, with an angle α between a first tangent 20 along the first straight coupling housing section 18 and the longitudinal axis of the coupling ring 13 being greater than an angle β between a second tangent 21 along the second straight coupling housing section 19 and the longitudinal axis of the coupling ring 13. A provision is made here that the first tangent 20 and the second tangent 21 lie on the same plane as the longitudinal axis of the coupling ring 13, i.e., on the horizontal pivot plane 9. As a result, seizing of the coupling ring 3 in the receiver 5 can be prevented with particular ease, in particular when a clearance 37 is formed between the coupling ring 3 and the receiver 5 in the fixed state 7 and in the second receiver section 16. Furthermore, the different angles make it possible to ensure that the coupling ring 3 is securely seated in the receiver 5 in the fixed state 7.

Preferably, a provision can be made that the second coupling housing section 19 is longer than the first coupling housing section 18. Preferably, the length of the second coupling housing section 19 is at least twice, preferably at least three times, the length of the first coupling housing section 18.

Especially preferably, a provision can be made that, in the fixed state 7, the end region of the coupling ring 3 arranged in the receiver 5 rests only partially against the second coupling housing section 19. This is illustrated by way of example in FIG. 6. As a result, the clearance 37 can be formed between the end region of the coupling ring 3 in the second receiving section 16 and the second coupling housing section 19. This enables the range of movement of the coupling ring 3 in the lateral direction to the longitudinal axis of the coupling ring 13 in the mobile state 8 to be increased in a simple manner. Furthermore, this can reduce the risk of the coupling ring 3 seizing in the receiver 5.

Preferably, a provision can be made that the length of the recess 12 along the longitudinal axis of the coupling ring 13 is at least 25%, especially preferably at least 30%, preferably at least 50%, of the length of the second receiving section 16.

Especially preferably, a provision can be made that the coupling housing 2 comprises a third receiving section 22 adjoining the second receiving section 16 and extending along the longitudinal axis of the coupling ring 13, and that the recess 11 adjoins the third receiving section 22. As a result, the range of motion of the coupling ring 3 in the lateral direction to the longitudinal axis of the coupling ring 13 in the mobile state 8 can be further improved.

A provision can be especially preferably made that—in a section parallel to the horizontal pivot plane 9—the coupling housing 2 has an at least partially rounded third coupling housing section 23 on the side of the receiver 5 facing the at least one longitudinal side of the coupling housing 17 in the third receiver section 22. The at least partially rounded third coupling housing section 23 is shown as an example in FIG. 6. As a result, an end of the receiver 5 can be formed in the receiver 5 with particular ease, this end reducing damage to the end region of the coupling ring 3 arranged in the receiver 5 when it strikes the end. The end of the receiver 5 is the point farthest from the coupling element 4 at which the coupling ring 3 rests when inserted into the receiver 5.

Preferably, the length of the first receiving section 15 is at least 10%, preferably at least 20%, of the length of the receiver 5. Preferably, the length of the second receiving section 16 is at least 45%, especially preferably at least 55%, preferably at least 65%, of the length of the receiver 5. Preferably, the length of the third receiving section 22 is at least 10%, preferably at least 15%, of the length of the receiver 5. The length of the receiver 5 and the lengths of the receiver sections 15, 16, 22 are measured along the longitudinal axis of the coupling ring 13 and in the fixed state 7.

Preferably, in the fixed state 7, the end region of the coupling ring 3 arranged in the third receiving section 22 can be designed to be opposite the third coupling housing section 23. Preferably, the end of the coupling ring 3 arranged in the receiver 5 can be rounded. By virtue of the rounded end of the coupling ring 3, a lateral pivoting movement of the coupling ring 3 can ensure that the end is guided along the third coupling housing section 23 or the second coupling housing section 19. This can reduce the wear of the coupling ring 3 in the receiver 5 and make it easier to return the coupling device 1 to the locking position.

Preferably, the receiver 5 can comprise only the first receiver section 15, the second receiver section 16, and the third receiver section 22.

Especially preferably, a provision can be made that, in the fixed state 7, the end region of the coupling ring 3 arranged in the receiver 5 rests at least partially in the third receiver section 22 against the coupling housing 2. Preferably, the end of the coupling ring 3 arranged in the receiver 5 can rest against the coupling housing 2 in the fixed state 7. This is illustrated by way of example in FIG. 6. This makes it particularly easy to return the coupling device 1 to the locking position. As a result, the coupling ring 3 only needs to be inserted into the receiver 5 until the end of the coupling ring 3 rests against the coupling housing 2 and then fixed in place by means of the locking device 6.

Preferably, in the fixed state 7, the end region of the coupling ring 3 in the third receiving section 22 can rest against the at least partially rounded third coupling housing section 23.

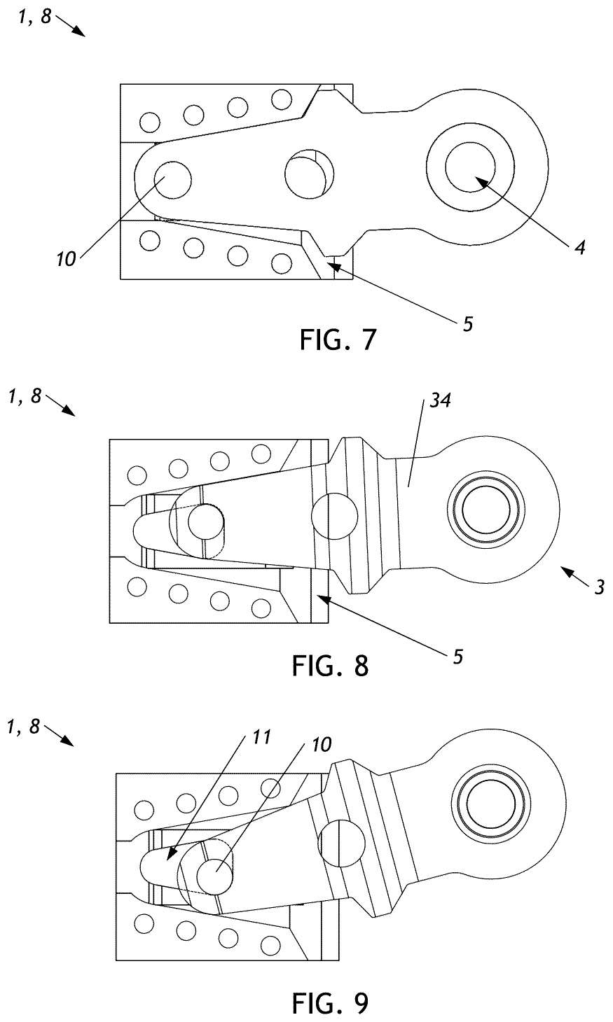

To couple the coupling device 1 to the trailer hitch 28, the locking device 6 is preferably released first. As a result, the coupling device 1 is transferred from the fixed state 7 to the mobile state 8. The fixed state 7 of the coupling device 1 is shown for the sake of example in FIG. 6. The mobile state 8 of the coupling device 1 is shown by way of example in FIGS. 7 to 9, with FIG. 8 showing the section of the coupling device 1 shown in FIG. 6 in the mobile state 8 in a first lateral or horizontally pivoted position of the coupling ring 3 and FIG. 9 showing the section of the coupling device 1 shown in FIG. 6 in the mobile state 8 with the coupling ring 3 in a second lateral or horizontally pivoted position. In FIG. 7, another section parallel to the horizontal pivot plane 9 of the coupling device 1 is visible, and it is evident that no common through hole for the pin of the locking device 6 is formed anymore. As can be clearly seen from a comparison of FIGS. 7 to 9, the coupling ring 3 can assume different pivoting positions in the horizontal pivoting plane 9. In other words, the coupling ring 3 is floatingly supported in the mobile state 8. The movement of the coupling ring 3 is limited by the size and shape of the recess 11 and of the movement-limiting part 11.

In the mobile state 8, the coupling element 4 of the coupling ring 3 is coupled to the trailer hitch 28, for example by arranging the coupling pin 29 of the trailer hitch 28 in the coupling ring hole 36. Subsequently, the tractor to which the trailer hitch 28 is attached or the vehicle trailer to which the coupling device 1 is attached is moved such that the coupling ring 3 is guided into the receiver 5. This can also be referred to as “driving to the block.” In particular, by virtue of the rounded end of the coupling ring 3 and the tapering shape of the receiver 5 into the receiver 5, this can be achieved by guiding the coupling ring 3, in particular the rounded end of the coupling ring 3, along the coupling housing wall of the receiver 5 until the coupling ring 3 rests with its end against the end of the receiver 5 and is thus positioned in the receiver 5. In this position, the coupling device 1 is preferably in the locking position. In this position, the coupling device 1 is then fixed with the locking device 6, for example by arranging the pin in the common through hole.

Preferably, a method for uncoupling the trailer hitch 28 with the coupling device 1 according to the invention can also be provided, the coupling device 1 being transferred from the fixed state 7 into the mobile state 8 by means of the locking device 6 and, in the mobile state 8, the coupling ring 3 being uncoupled from the trailer hitch 28 by means of the coupling element 4.

In particular, when uncoupling the trailer hitch 28 and the coupling device 1, the tractor to which the trailer hitch 28 is attached or the vehicle trailer to which the coupling device 1 is attached can be moved in the direction in which the coupling ring is guided into the receiver 5. This makes it possible for a lower level of stress to be applied to the pin, particularly if the locking device 6 is embodied as a pin. This makes it easier to remove the pin from the through hole, particularly to knock it out. This transfer of the coupling device 1 from the fixed state 7 to the mobile state 8 reduces the tension between the coupling element 4 and the coupling member of the trailer hitch 28, in particular of the coupling pin 29. This also makes the end coupling between the coupling ring and the trailer hitch 28—i.e., pulling out the coupling pin 29—significantly easier than with conventional coupling types.

A provision can be especially preferably made that, in a longitudinal section through the coupling device 1 and in the fixed state 7, the height 24 of the coupling ring 3 in the first receiving section 15 corresponds substantially to the height of the receiver 5 in the first receiving section 15 at at least one point along the longitudinal axis of the coupling ring 13, and the height 25 of the coupling ring 3 in the third receiving section 22 corresponds substantially to the height of the receiver 5 in the third receiving section 22. This is illustrated by way of example in FIG. 5. This enables a secure seating of the coupling ring 3 in the receiver 5 in the fixed state 7 to be achieved, making it possible to prevent a vertical pivoting movement of the coupling ring 3. The coupling ring 3 can have varying heights along the longitudinal extent in the fixed state, in which case it is necessary for the height of the coupling ring 24, 25 and the height of the receiver 5 to be substantially the same at at least one point along the first receiving section 15 and the third receiving section 22 in order for the secure seating of the coupling ring 3 to be achieved in the fixed state 7.

Especially preferably, a provision can be made that, in a longitudinal section through the coupling device 1 and in the fixed state 7, the height of the coupling ring 27 in the second receiving section 16 is smaller than the height 26 of the receiver 5 in the second receiving section 16 in at least one region along the longitudinal axis of the coupling ring 13. This is illustrated for the sake of example in FIGS. 5 and 12. FIG. 12 shows a longitudinal section through the preferred embodiment of the coupling device 1 in the mobile state 8 in a horizontal end position.

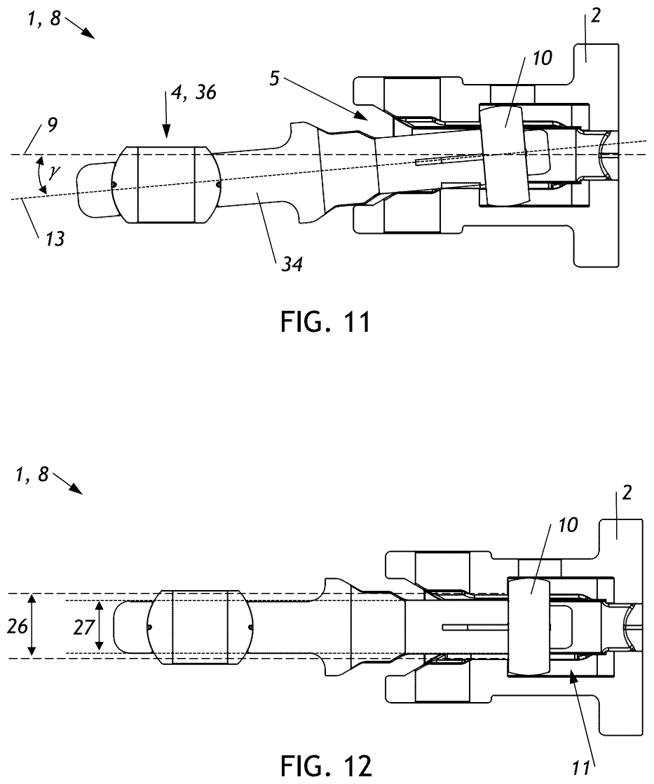

In the horizontal end position, the coupling ring 3 is pulled horizontally out of the receiver 5, and the coupling ring 3 is not pivoted vertically. FIG. 11 shows another longitudinal section through the preferred embodiment of the coupling device 1 in the mobile state 8 in a vertically pivoted position. This makes it possible for the coupling ring 3 to be pivoted vertically in the mobile state 8. This can be advantageous particularly if a ball joint coupling ring and/or if play-limiting spacers are used between the coupling ring 3 and a towing jaw of the trailer hitch 28 in order to reduce vertical play, i.e., the open area between the coupling ring 3 and the towing jaw when the trailer hitch 28 is coupled.

Preferably, the coupling ring 3 can be pivoted vertically in the mobile state 8 by at least 2 degrees, especially preferably at least 3 degrees, preferably at least 5 degrees, relative to the horizontal pivot plane 9 and/or the fixed state 7. In FIG. 11, an angle γ is shown as an example to illustrate the vertical pivotability of the coupling ring 3. The angle γ shows the angle between the longitudinal axis of the coupling ring 13 in the mobile state 8 and the horizontal pivot plane 9.

Preferably, in the longitudinal section through the coupling device 1 and in the fixed state 7, the height of the receiver 5 in the first receiver section 15 can be greater than the height 26 of the receiver 5 in the second receiver section 16 in at least one region along the longitudinal axis of the coupling ring 13. As a result, in synergy with the smaller design of the height 27 of the coupling ring 3 in the second receiving section 16 compared to the height 26 of the receiver 5 in the second receiving section 16, an especially effective vertical pivoting of the coupling ring 3 can be achieved.

Preferably, in the longitudinal section through the coupling device 1 and in the fixed state 7, the height 26 of the receiver 5 in the second receiver section 16 can be greater than the height of the receiver 5 in the third receiver section 22 in at least one region along the longitudinal axis of the coupling ring 13.

Especially preferably, a provision can be made that the coupling ring 3 is mirror-symmetrical about the longitudinal axis 13. This enables the inventive effects of the coupling ring 3, in particular the alignment of the coupling ring 3 in the receiver 5—i.e., the transfer of the coupling device 1 into the locking position—to be achieved in an especially simple manner.

Preferably, the coupling device 1—in the fixed state 7 and as measured along the longitudinal axis of the coupling ring 13—is at least 20 cm, especially preferably at least 25 cm, in particular at least 30 cm, long.

The unit “ton” refers to the metric ton.

The following are principles for understanding and interpreting the present disclosure.

Features are usually introduced with an indefinite article “a, an, one.” Unless the context indicates otherwise, “a, an, one” should therefore not be understood as constituting a numeral.

For value ranges, the end points are included insofar as not otherwise indicated by the context.

1-15. (canceled)

16. A coupling device for a vehicle trailer, comprising:
a coupling housing; and
a coupling ring with a coupling element;
wherein an end region of the coupling ring opposite the coupling element is arranged in a receiver of the coupling housing;
wherein the coupling ring can be transferred between a fixed state and a mobile state by a locking device of the coupling device;
wherein the coupling ring is connected in a substantially rigid manner to the coupling housing in the fixed state and is movable in the mobile state at least within a limited range of movement relative to the coupling housing on a horizontal pivot plane;
wherein a substantially rod-shaped movement-limiting part is formed on the end region of the coupling ring arranged in the receiver;
wherein at least one end region of the rod-shaped movement-limiting part is in a recess in the receiver arranged recess of the coupling housing and in the mobile state limits the movement of the coupling ring relative to the coupling housing; and
wherein, as measured in the fixed state, the length of the recess along the longitudinal axis of the coupling ring is at least 1.5 times the thickness of the movement-limiting part along the longitudinal axis of the coupling ring.

17. The coupling device according to claim 16, wherein, in a section parallel to the horizontal pivot plane, the end region of the coupling ring arranged in the receiver of the coupling housing tapers into the receiver.

18. The coupling device according to claim 16, wherein, in a section parallel to the horizontal pivot plane, the recess of the coupling housing tapers into the receiver.

19. The coupling device according to claim 16, wherein the coupling housing comprises a first receiving section in the direction of the receiver and a second receiving section following the first receiving section along the longitudinal axis of the coupling ring, and that the recess of the coupling housing is arranged in the second receiving section.

20. The coupling device according to claim 19, wherein, in a section parallel to the horizontal pivot plane, the coupling housing has, on at least one side of the receiver facing a longitudinal side of the coupling housing, a substantially straight first coupling housing section in the first receiver section and a substantially straight second coupling housing section in the second receiver section, with an angle (α) between a first tangent along the first straight coupling housing section and the longitudinal axis of the coupling ring being greater than an angle (β) between a second tangent along the second straight coupling housing section and the longitudinal axis of the coupling ring.

21. The coupling device according to claim 20, wherein, in the fixed state, the end region of the coupling ring arranged in the receiver rests only partially against the second coupling housing section.

22. The coupling device according to claim 19, wherein the coupling housing comprises a third receiving section adjoining the second receiving section and extending along the longitudinal axis of the coupling ring, and that the recess adjoins the third receiving section.

23. The coupling device according to claim 22, wherein, in a section parallel to the horizontal pivot plane, the coupling housing has an at least partially rounded third coupling housing section on the side of the receiver facing the at least one longitudinal side of the coupling housing in the third receiver section.

24. The coupling device according to claim 23, wherein, in the fixed state, the end region of the coupling ring arranged in the receiver rests at least partially against the coupling housing in the third receiver section.

25. The coupling device according to claim 22, wherein, in a longitudinal section through the coupling device and in the fixed state, the height of the coupling ring in the first receiving section corresponds substantially to the height of the receiver in the first receiving section at at least one point along the longitudinal axis of the coupling ring, and the height of the coupling ring in the third receiving section corresponds substantially to the height of the receiver in the third receiving section.

26. The coupling device according to claim 16, wherein, in a longitudinal section through the coupling device and in the fixed state, the height of the coupling ring in the second receiving section is smaller than the height of the receiver in the second receiving section in at least one region along the longitudinal axis of the coupling ring.

27. The coupling device according to claim 16, wherein the coupling ring is mirror-symmetrical about the longitudinal axis.

28. The coupling device according to claim 16, wherein the coupling housing is composed of at least two plates and that the receiver of the coupling housing is formed in at least one of the at least two plates.

29. The coupling device according to claim 16, wherein the locking device is a locking pin, the locking pin configured to be inserted through a common through hole of the coupling ring and the coupling housing.

30. A method for coupling a trailer hitch to a coupling device, comprising:
providing the coupling device for the vehicle trailer, the coupling device including a coupling housing and a coupling ring with a coupling element;
wherein an end region of the coupling ring opposite the coupling element is arranged in a receiver of the coupling housing;
wherein the coupling ring can be transferred between a fixed state and a mobile state by a locking device of the coupling device;
wherein the coupling ring is connected in a substantially rigid manner to the coupling housing in the fixed state and is movable in the mobile state at least within a limited range of movement relative to the coupling housing on a horizontal pivot plane;
wherein a substantially rod-shaped movement-limiting part is formed on the end region of the coupling ring arranged in the receiver;
wherein at least one end region of the rod-shaped movement-limiting part is in a recess in the receiver arranged recess of the coupling housing and in the mobile state limits the movement of the coupling ring relative to the coupling housing;
wherein, as measured in the fixed state, the length of the recess along the longitudinal axis of the coupling ring is at least 1.5 times the thickness of the movement-limiting part along the longitudinal axis of the coupling ring;
wherein the coupling device is transferred from the fixed state into the mobile state by means of the locking device;
wherein, in the mobile state, the coupling ring is coupled to the trailer hitch by the coupling element; and
wherein, after the coupling of the coupling ring with the trailer hitch the coupling ring is brought into a locking position and the coupling device is fixed in the fixed state by means of the locking device.
